(19) United States
(12) Patent Application Publication
(10) Pub. No.: US 2013/0099028 A1
(43) Pub. Date: Apr. 25, 2013

(54) BAG RIGIDIZER

(71) Applicants: Sevrey Richard, Bristol, IN (US); Jeffrey D. Kendall, Laurel, MD (US)

(72) Inventors: Sevrey Richard, Bristol, IN (US); Jeffrey D. Kendall, Laurel, MD (US)

(73) Assignee: EARTHWAY PRODUCTS INC., Bristol, IN (US)

(21) Appl. No.: 13/648,759

(22) Filed: Oct. 10, 2012

Related U.S. Application Data
(60) Provisional application No. 61/548,947, filed on Oct. 19, 2011.

(51) Int. Cl. A01C 15/00

(52) U.S. Cl. CPC A01C 15/006
USPC 239/668; 29/428

(57) ABSTRACT

A particulate material dispensing apparatus is provided that includes a base, a collapsible hopper attached to a top of the base to hold particulate material, at least one support removably attached to the base that extends in a direction away from the top of the base such that the at least one support engages the collapsible hopper to provide a means to maintain the collapsible hopper in an upright position. The apparatus further includes a dispensing mechanism that when actuated dispenses the particulate material through the base and an impeller rotatably actuated upon actuation of the dispensing mechanism to thereby distribute the particulate material dispensed through the base.

### CROSS-REFERENCE TO RELATED APPLICATIONS

This application claims the benefit of U.S. Provisional Patent application Ser. No. 61/548,947 entitled “BAG RIGIDIZER” filed on Oct. 19, 2011. The entirety of the above-noted application is incorporated by reference herein.

### ORIGIN

The innovation disclosed herein relates to lawn seeders/spreaders and more specifically, to a bag type seeder/spreader having a feature to facilitate filling the bag with spreadable material.

### BACKGROUND

Conventional seeders and spreaders come in many varieties and designs. For example, one type of seeder/spreader includes a nylon bag hopper that houses spreadable material (e.g., seeds). One common type of a bag hopper seeder/spreader is a hand held type that may also include a contoured base that suitably conforms to a user's hip and is attached to the bag hopper, an adjustable shoulder strap and a long crank handle. Hand held seeder/spreaders are ideal when the terrain is hilly and/or wet.

Many of these types of spreaders are equipped with a corrosion, tear and weather resistant 20 lb/9 kg nylon bag hopper that includes a zippered top for convenient filling and closure. Although, the bag hopper is collapsible for easy storage, the bag hopper does not remain in an upright rigid position when filing. As such, while the hand held, bag-type spreaders are very convenient to use, they lack in convenience of filling. Thus, there is a need in the art for an apparatus that can be used with the bag-type family of spreaders that enhances the ease and ability to fill the bag hopper.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In an aspect of the innovation, A particulate material dispensing apparatus is provided that includes a base, a collapsible hopper attached to a top of the base to hold particulate material, at least one support removably attached to the base and extending in a direction away from the top of the base such that the at least one support engages the collapsible hopper to provide a means to maintain the collapsible hopper in an upright position, a dispensing mechanism that when actuated dispenses the particulate material through the base and an impeller rotatably actuated upon actuation of the dispensing mechanism to thereby distribute the particulate material dispensed through the base.

In another aspect of the innovation, the at least one support is made from a non-deformable material having a thickness such that the at least one support can be flexed in a forward and rearward direction a height less than but nearly equal to a height of the collapsible hopper, and a width less than half the height of the at least one support.

In yet another aspect of the innovation, a hand-held seeder/spreader is provided that includes a base having a concave curved portion to closely conform the base to a user's torso or hip, a bag hopper attached to a top of the base to hold seed or fertilizer, a pair of supports removably attached to opposite ends or sides of the base and extending in a direction away from the top of the base such that the pair of supports engage the bag hopper to provide a means to maintain the bag hopper in an upright position, a crank mechanism that when actuated dispenses the seed or fertilizer through the base, and an impeller rotatably actuated upon actuation of the crank mechanism to thereby distribute the seed of fertilizer dispensed through the base.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a perspective view of a particulate dispersing apparatus incorporating an innovative collapsible hopper support in accordance with an aspect of the innovation.

FIG. 2 is a perspective view of a base and innovative supports in accordance with an aspect of the innovation.

FIG. 3 is a top view of the base of FIG. 2 without the supports in accordance with an aspect of the innovation.

FIG. 4 is a perspective view of the base illustrating a placement of a support in accordance with an aspect of the innovation.

FIGS. 5A-5C are example embodiments of the support in accordance with an aspect of the innovation.

FIG. 6 is a close-up top view of the cover inside the collapsible hopper in accordance with an aspect of the innovation.

FIG. 7 is a view illustrating installation of a support into the base in accordance with an aspect of the innovation.

FIG. 8 is another view illustrating the installation of the support into the base in accordance with an aspect of the innovation.

FIG. 9 is a view illustrating the support installed in the base in accordance with an aspect of the innovation.

FIG. 10 is a flow chart diagram illustrating a method of installing the support into the base in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

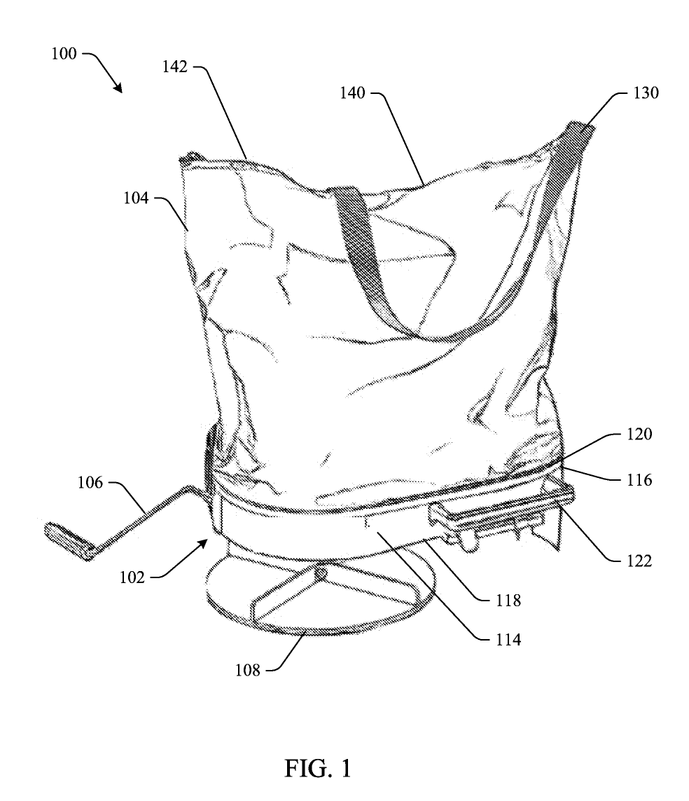

With reference now to the figures, FIG. 1 is a perspective view of a particulate dispersing apparatus 100 (hereinafter “dispersing apparatus”) that disperses particulate material, such as but not limited to, grass seed, fertilizer, salt, etc. incorporating an innovative support or rigidizing device in accordance with an aspect of the innovation. The support device is adapted to maintain a collapsible-bag type hopper in an upright position to facilitate the filling of the hopper with a particulate material. The dispersing apparatus 100 may be any type of apparatus capable of dispersing particulate material, such as but not limited a lawn seed/fertilizer spreader, a salt spreader, etc. In addition, the dispersing apparatus 100 may be a walk behind type spreader or a hand-held type spreader. For purposes of illustration only, the embodiment described herein and illustrated in the figures is a hand-held type spreader and is not intended to limit the scope of the innovation.

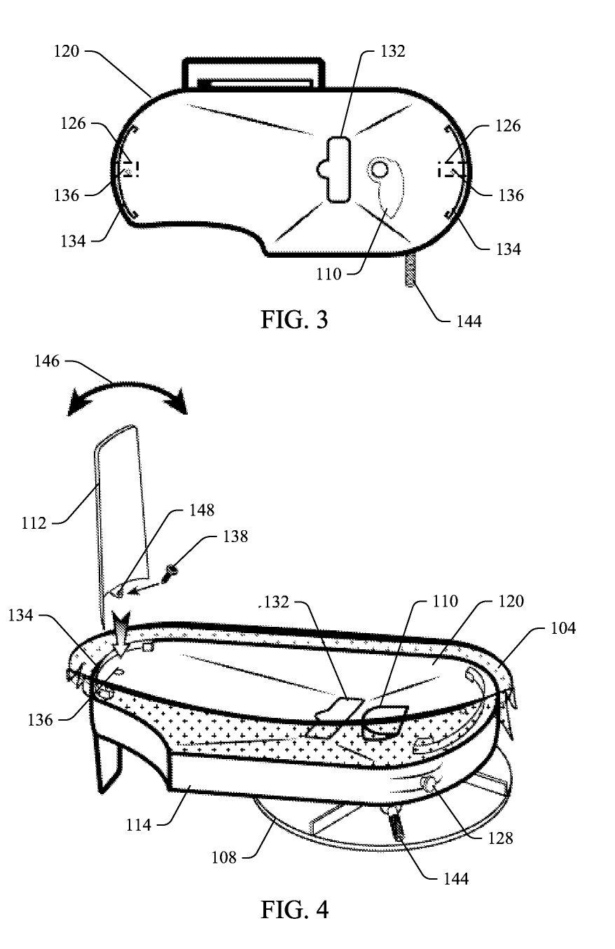

Referring to FIGS. 1-4, the dispersing apparatus 100 includes a base 102, a flexible/collapsible (non-rigid) bag-type hopper 104, a dispensing mechanism 106 (e.g., wheels of a walk behind spreader, crank handle of a hand-held spreader), an impeller 108, an agitator 110, and one or more hopper (bag) supports 112. It should be understood and noted that, although specific shapes, dimensions, placements, orientations, configurations, attachment techniques are disclosed herein, variations exist all of which are to be included within the scope of this disclosure and claims appended hereto.

The base 102 is comprised of a frame 114 having an open top 116 and bottom 118, and a cover 120 that attaches to the top 116 of the frame 114. A handle 122 is attached to the frame to assist the user in dispensing the particulate material. The base 102 has an oval shape with a concave curved portion 124 to conform the base 102 to a user's torso or hip area. It is to be appreciated, however, that the shape of the base may be any geometrical shape, such as but not limited to, circular, square, rectangular, etc. A projection 126 is disposed on opposite ends or sides of the frame 114. Each projection 126 extends inward toward the opposite projection 126 and, in one embodiment, is used to secure the supports 112 to the base 102, as will be described further below. The frame 114 further includes multiple attachment tabs 128 to facilitate the attachment of a strap 130 to assist the user in carrying the dispersing apparatus 100.

The cover 120 has a crowned surface and, as mentioned above, attaches to the top 116 of the frame 114. An aperture 132 is defined at a lowest point in the crowned surface cover 120. The agitator 110 is rotatably situated atop the cover and, when actuated, rotates to dispense the particulate material through the aperture 132. A slot 134 is defined at each end or side of the cover 120 adjacent to each projection 126. Each slot 134 is adapted to receive a support 112, as will be described further below. A fastening aperture 136 is defined at each end or side of the cover 120 adjacent to each slot 134. In another embodiment, the fastening apertures 136 are adapted to receive a fastener 138 to secure each support 112 to the base 102, as will be described further below.

The bag-type hopper 104, as mentioned above, attaches to a top 116 of the base 114 such that the bag hopper 104 encloses the cover 120. The bag hopper 104 is a made from a collapsible/flexible (non-rigid), yet non-deformable material, such as but not limited to, nylon, canvas, etc. In an embodiment, the material may be corrosion resistant, tear resistant, weather resistant, etc. The bag hopper 104 includes a closable top opening 140 and a means to facilitate opening and closing the top opening 140, such as but not limited to a zipper 142 (shown in the example embodiment in the figures), snaps, buttons, Velcro®, etc.

In the example embodiment illustrated in the figures the dispensing mechanism 106 is comprised of a crank handle. It is to be appreciated, however, that the dispensing mechanism may be comprised of wheels on a walk behind type seeder/spreader. When the operator rotates the crank handle, both the impeller 108 and the agitator 110 rotate to thereby disperse or distribute the granular material. The crank handle attaches to a rotating shaft 144 extending from below the frame 114. The shaft 144 is attached to both the impeller 108 and the agitator 110 via gearing and, thus, when rotated by the crank handle operatively rotates both the impeller 108 and the agitator 110 to distribute the granular material.

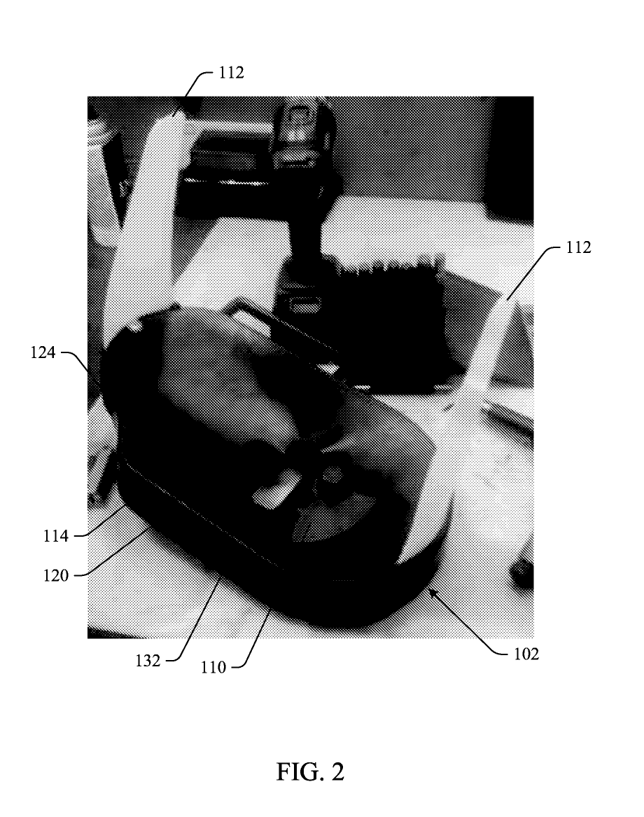

Referring to FIGS. 2-5C, the hopper (bag) supports 112 are made from a flexible, non-deformable material, such as but not limited to, plastic, a polymer, etc. The supports 112 can be manufactured by molding, cut from sheet stock, wire-frame or band-frame materials, etc.

The supports 112 have a thickness such that the supports 112 can be flexed in a forward and rearward direction as indicated by the arrow 146, a height less than but nearly equal to a height of the collapsible hopper 104, and a width less than half the height the supports 112. The supports 112 are secured to the base 102 and extend in a direction away from the top 116 of the base 102 such that the supports engage the collapsible hopper 104 to provide a means to maintain the collapsible hopper 104 in an upright position.

In one embodiment, the supports 112 may extend away from the top 116 of the base 102 and be disposed on the inside of the collapsible hopper 104. In another embodiment, the supports 112 may extend away from the top 116 of the base 102 and be disposed on the outside of the collapsible hopper 104, whereby the collapsible hopper 104 includes pockets or sleeves to receive the upper portion of the supports 112. In yet another embodiment, the supports 112 may extend away from the top 116 of the base 102 and be disposed in a sleeve that extends along the entire side of the collapsible hopper 104.

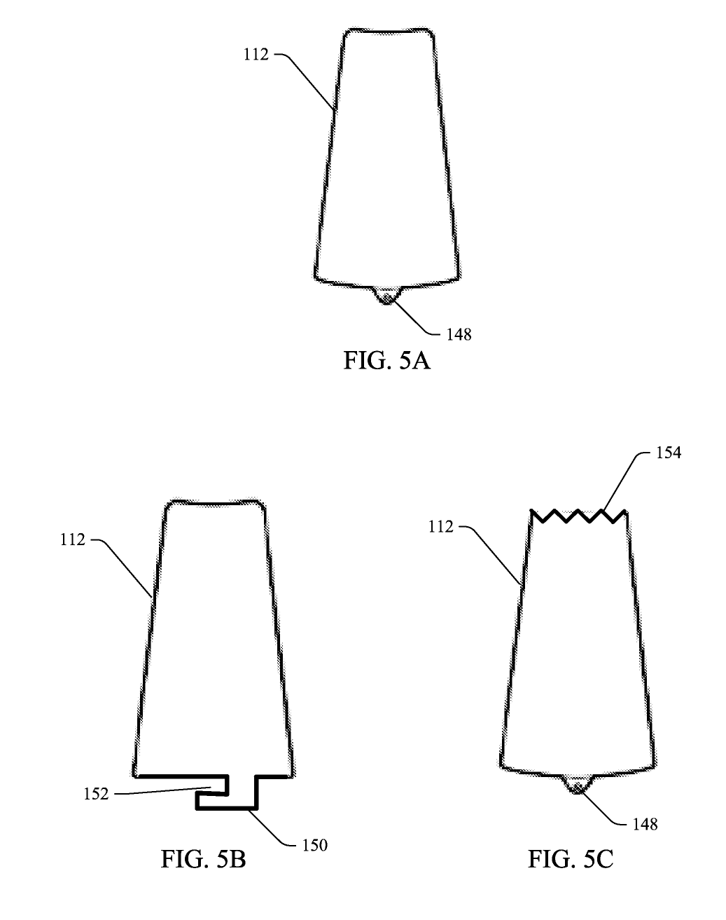

In one embodiment, shown in FIG. 5A, the supports 112 include a tab aperture 148 to receive the fastening device 138 mentioned above. The fastening device 138 is inserted through the tab aperture 138 and into the fastening aperture 136 and tightened (i.e., threaded) to secure the supports in the base 102. It is to be appreciated, however, that the means to secure the supports 112 to the base 102 may be any mechanical means to secure the supports 112 to the base, such as but not limited to, riveting, screwing, gluing, etc. It is to be further appreciated that the supports 112 may be a fixed integrated portion of the base 102.

For example, in another embodiment, shown in FIG. 5B, the supports 112 include a hook type tab 150 that engages the projections 126 disposed on the frame 114. Specifically, each support 112 is inserted into the corresponding slot 134 defined in the cover 120 and slid in a direction such that each projection 126 resides in a space 152 defined by the hook tab 150 to secure the supports 112 in the base 102.

In yet another embodiment, shown in FIG. 5C, the supports 112 may include a texturized top edge 154. In one example, the texturized top edge 154 may be in the form of a jagged edge (or teeth). It is to be appreciated, however, that the texturized top edge may take any form. The texturized top edge 154 facilitates a gripping of the supports 112 to the collapsible hopper 104. In other words, the texturized top edge 154 can engage and penetrate portions of the collapsible hopper 104 to secure the top of the supports 112 to the collapsible hopper 104.

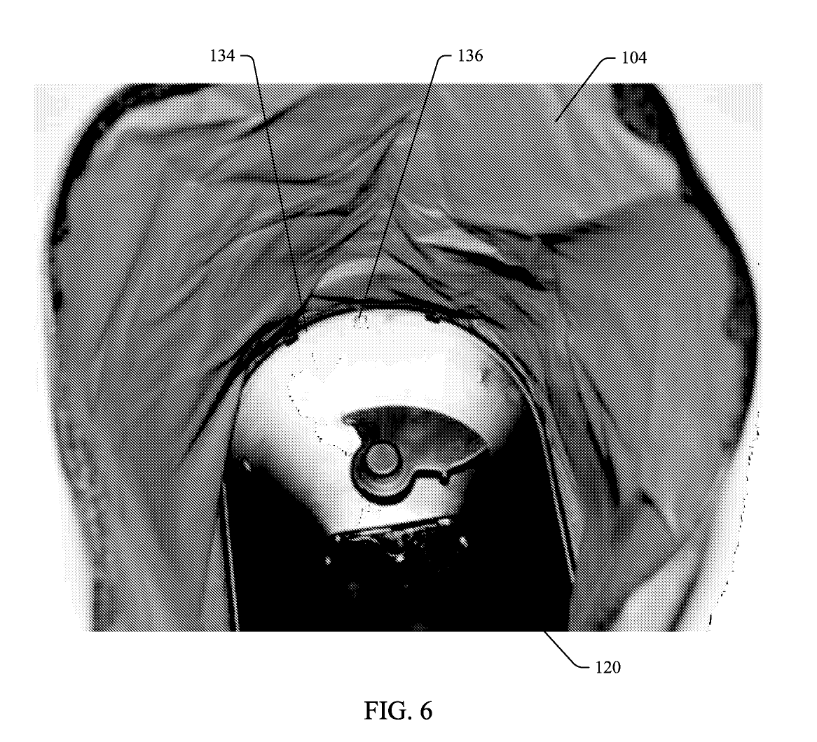

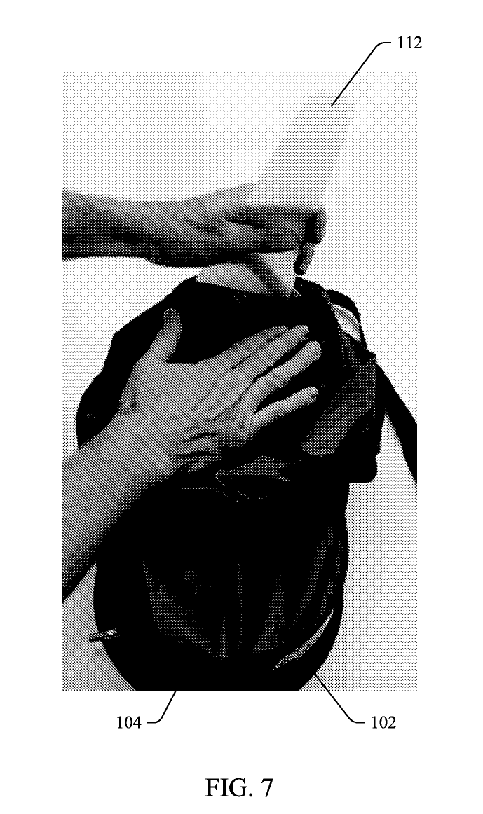

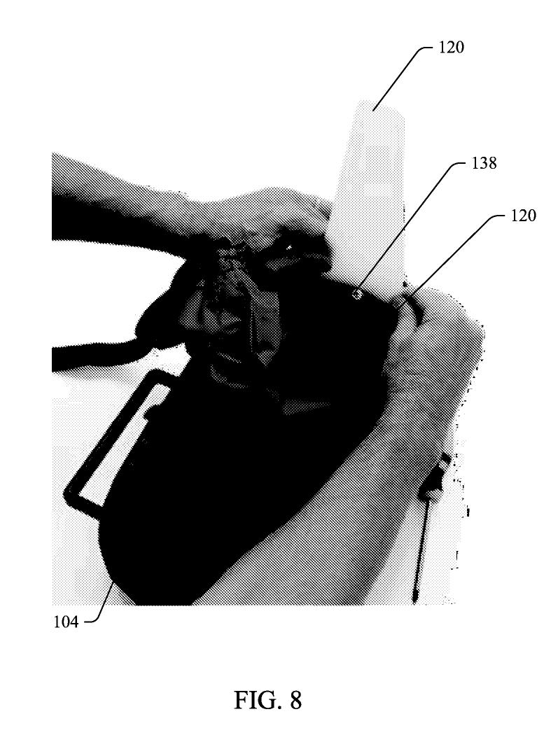

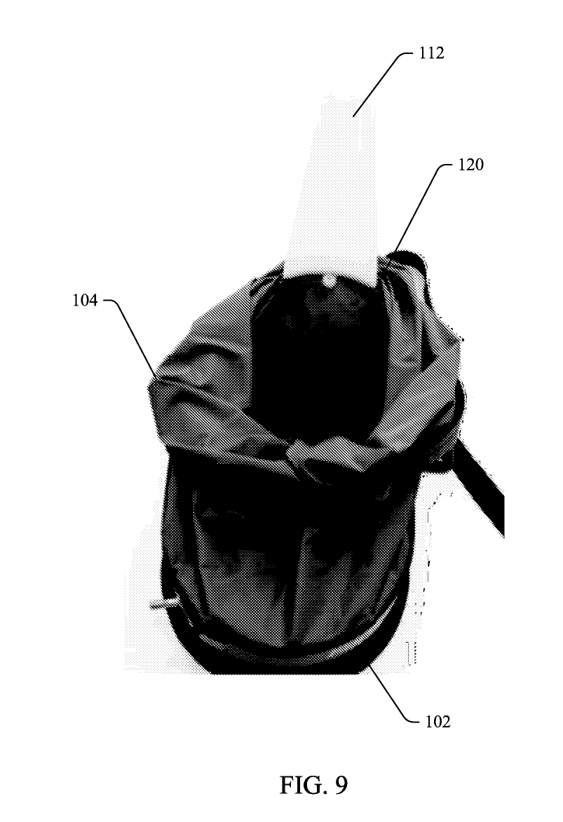

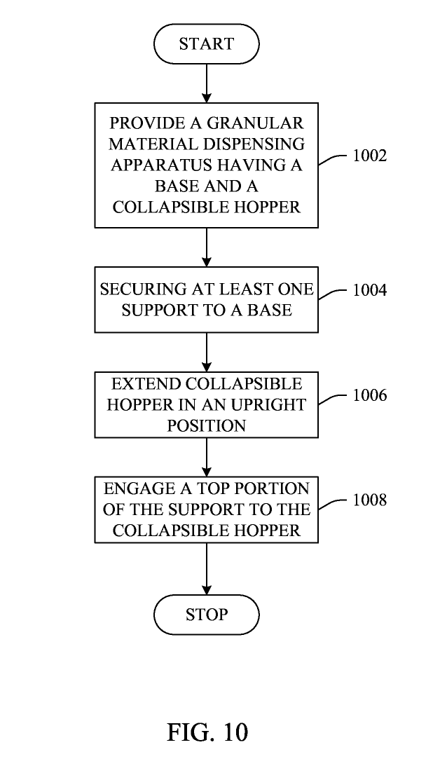

Referring to FIGS. 6-10 a method of installing the supports 112 in a dispersing apparatus 100 to facilitate filling the collapsible hopper 104 with a particulate material will now be described. At 1002, a particulate material dispensing apparatus is provided that includes a base 102 and a collapsible hopper 104. At 1004, a collapsible hopper (or bag) support 112 is secured to opposite ends or sides of the base 102. Specifically, in one embodiment, a bottom portion of the supports are inserted into the slots 134 defined in the cover 120 and the fastening device 138 is inserted through the tab aperture 148 in the support 112 and into the fastening aperture defined in the cover 120. In another embodiment, the bottom portion of the supports are inserted into the slots 134 defined in the cover 120 and the supports 112 are slid in a direction such that each projection 126 resides in a space 152 defined by the hook tab 150 to secure the supports 112 in the base 102. At 1006, the collapsible hopper 104 is extended in an upright position. At 1008, a top portion of each support 112 is engages the inside of the collapsible hopper 104. For example, in one embodiment, the texturized top edge 154 engages and penetrates the collapsible hopper 104 thereby securing the collapsible hopper 104 in an upright position.

As mentioned above, the innovative support device disclosed herein is adapted to maintain a collapsible-bag type hopper in an upright position to facilitate the filling of the hopper with a particulate material.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A particulate material dispensing apparatus comprising:
a base;
a collapsible hopper attached to a top of the base to hold particulate material;
at least one support removably attached to the base and extending in a direction away from the top of the base such that the at least one support engages the collapsible hopper to provide a means to maintain the collapsible hopper in an upright position;
a dispensing mechanism that when actuated dispenses the particulate material through the base; and
an impeller rotatably actuated upon actuation of the dispensing mechanism to thereby distribute the particulate material dispensed through the base.

2. The particulate material dispensing apparatus of claim 1, wherein the at least one support is made from a non-deformable material having a thickness such that the at least one support can be flexed in a forward and rearward direction, a height less than but nearly equal to a height of the collapsible hopper, and a width less than half the height of the at least one support.

3. The particulate material dispensing apparatus of claim 2, wherein the at least one support includes a first support removably attached on one end or side of the base and a second support removably attached to an opposite end or side of the base, and wherein a bottom portion of the first support is inserted and secured into a first slot defined at the one end or side of the base and a bottom portion of the second support is inserted and secured into a second slot defined at the opposite end or side of the base.

4. The particulate material dispensing apparatus of claim 3, wherein an aperture is defined in the bottom portion of the first support and in the bottom portion of the second support and wherein a fastening device is inserted through each aperture and into an aperture defined adjacent to each slot defined in the base to thereby secure the first support and the second support to the base.

5. The particulate material dispensing apparatus of claim 3, wherein the bottom portion of the first support and the bottom portion of the second support each include a hook tab that slidably engages a tab disposed adjacent to each slot defined in the base to secure the first support and the second support to the base.

6. The particulate material dispensing apparatus of claim 3, wherein the first support and the second support are disposed inside the collapsible hopper.

7. The particulate material dispensing apparatus of claim 3, wherein a top of the first support and a top of the second support are texturized to facilitate a gripping of the top of the first and second supports to an upper portion of the collapsible hopper.

8. The particulate material dispensing apparatus of claim 2, wherein the collapsible hopper is a bag-type hopper made from a flexible material.

9. A hand-held seeder/spreader comprising:
a base having a concave curved portion to conform the base to a user's torso or hip;
a bag hopper attached to a top of the base to hold seed or fertilizer;
a pair of supports removably attached to opposite ends or sides of the base and extending in a direction away from the top of the base such that the pair of supports engage the bag hopper to provide a means to maintain the bag hopper in an upright position;
a crank mechanism that when actuated dispenses the seed or fertilizer through the base; and
an impeller rotatably actuated upon actuation of the crank mechanism to thereby distribute the seed of fertilizer dispensed through the base.

10. The hand-held seeder/spreader of claim 9, wherein the pair of supports are made from a non-deformable material having a thickness such that the pair of supports can be flexed in a forward and rearward direction, a height less than but nearly equal to a height of the bag hopper, and a width less than half the height of the pair of supports.

11. The hand-held seeder/spreader of claim 10, wherein the pair of supports are inserted and secured into a pair of corresponding slots defined on opposite ends or sides of the cover.

12. The hand-held seeder/spreader of claim 11, wherein an aperture is defined in a bottom portion of the pair of supports and wherein a fastening device is inserted through each aperture and into an aperture defined adjacent to each slot defined in the cover to thereby secure the pair of supports to the cover.

13. The hand-held seeder/spreader of claim 11, wherein a bottom portion of the pair of supports include a hook tab that slidably engages a tab extending from the frame and disposed adjacent to each slot defined in the cover to secure the pair of supports to the base.

14. The hand-held seeder/spreader of claim 11, wherein the pair of supports are disposed inside the bag hopper.

15. The hand-held seeder/spreader of claim 11, wherein a top of the pair of supports are texturized to facilitate a gripping of the top of the pair of supports to an upper portion of the bag hopper.

16. The hand-held seeder/spreader of claim 11 further comprising an agitator, wherein the base includes a frame and a cover attached to a top of the frame, the cover including a dispensing aperture, and wherein the agitator rotates upon actuation of the crank mechanism to disperse the seed or fertilizer through the dispensing aperture.

17. A method for assembling a particulate material dispensing apparatus to facilitate filling the particulate material dispensing apparatus with particulate material comprising:
providing a base and a collapsible hopper attached to a top of the base;
attaching removable supports on opposite sides of the base;
extending the collapsible hopper into an upright position; and
affixing a top portion of the removable supports to an upper portion of the collapsible hopper.

18. The method of claim 17, wherein attaching removable supports on opposite sides of the base includes inserting a bottom portion of the removable supports into slots defined on opposites ends or sides of the base; inserting a fastening device through an aperture defined in the bottom portion of the removable supports and into an aperture defined adjacent to each slot defined in the base; and securing the removable supports to the base.

19. The method of claim 17, wherein attaching removable supports on opposite sides of the base includes inserting a bottom portion of the removable supports into slots defined on opposites ends or sides of the base; sliding the removable supports in a direction such that a hook tab engages a projection disposed adjacent to each slot defined in the base to secure the removable supports to the base.

20. The method of claim 17, wherein affixing a top portion of the removable supports to an inside-upper portion of the collapsible hopper includes engaging a textured top of the removable supports to an inside portion of the collapsible hopper.
